(19) United States
(12) Patent Application Publication
(10) Pub. No.: US 2004/0175612 A1
(43) Pub. Date: Sep. 9, 2004

(54) Electrochemical cell

(76) Inventor: Allen Conti, Canfield, OH (US)

Correspondence Address: CLIFFORD A. POFF, 9800B MCKNIGHT ROAD, SUITE 115, PITTSBURGH, PA, 15237, US

(21) Appl. No.: 10/383,346

(22) Filed: Mar. 7, 2003

(51) Int. Cl. H01M 2/02; H01M 2/36

(52) U.S. Cl. 429/163; 429/34; 429/80

(57) ABSTRACT

An electrochemical cell is constructed with components having spherical, cylindrical, or conical, including truncated conical, geometrical configurations. The components are an anode and an air cathode having the form of an electrolyte container with an endless sidewall bounded by an air permeable exterior surface opposite to a cathodic reaction surface surrounding an internal volume. The air permeable exterior surface is liquid impermeable. The anode extends in the internal volume of the electrolyte container in a confronting and spaced relation from the reaction surface for forming an electrolyte reservoir there between. Electrical conductive terminals are coupled to the cathodic reaction surface and the anode. A battery is formed by a superimposed pair of electrochemical cells as part of an array of cells located in a container for the electrolyte.

### CROSS-REFERENCE TO RELATED APPLICATIONS

NOT APPLICABLE

### BACKGROUND OF THE INVENTION

1. Field of the Invention

The present invention relates to the construction and method for making an electrochemical cell useful to form fuel cells, semi-cells and batteries, and, more particularly, to geometric configurations of an anode internally of an electrolyte container incorporating an endless side wall of cathodic reaction surface communicating with an air permeable and liquid impermeable external surface to form an electrolyte reservoir of such an electrochemical cell.

2 Description of the Prior Art

The generation of electric forces in the field of electrochemistry occur by chemical reactions that convert chemical energy into electrical energy generally through an oxidation-reduction, (redox) process in the confines of electrochemical cells and may take the form of fuel cells, semi-cells, and batteries. The fundamental components of an electrochemical cell are negative and positive electrodes, (anode and cathode), an ionic conductor, (electrolyte), and an external electrical circuit to the work, (load.) Electrochemical cells, including the components, relations, and efficiencies are well known in the art. Differentiating fuel cells, semi-cells and batteries, however, has not been simple. The distinctions between these various electrochemical converters and generators are blurred because various combinations of electrode materials and electrolytes are assembled and therefore the traditional nomenclature becomes imprecise. The term “battery” is defined as a group of cells storing electrical power. The term “Fuel Cell” is defined as any of various devices collectively for the generation of electrical energy from the chemical energy of reaction of its various materials. The reaction material can be supplied continuously, intermittently or only initially and includes the possibility of a subsequent internal electrolysis to reconstitute initial component materials. The present invention is directed to the physical construction of an electrochemical cell particularly useful to form metal/air electrical generators.

As disclosed in U.S. Pat. No. 4,885,217 metal/air batteries produce electricity by the electro-chemical coupling of a reactive metallic anode to an air cathode through a suitable electrolyte in a cell. As is well known in the art, an air cathode is a typically sheet-like member, having opposite surfaces respectively exposed to the atmosphere and to the aqueous electrolyte of the cell wherein atmospheric oxygen ionically dissociates by operation of the cell and the anode metal of the cell ironical dissociates, providing an usable electric current flow through external circuitry connected between the anode and cathode. The air cathode must be permeable to air but substantially hydrophobic (so that aqueous electrolyte will not seep or leak through it), and must incorporate an electrically conductive element from which current can be collected and to which the external circuitry can be connected; for instance, in present-day commercial practice, the air cathode is commonly constituted of active carbon (with or without an added dissociation-promoting catalyst) containing a finely divided hydrophobic polymeric material and incorporating a metal screen as the current collecting conductive element. A variety of anode metals have been used or proposed; among them, alloys of aluminum and alloys of magnesium are considered especially advantageous for particular applications, owing to their low cost, lightweight, and ability to function as anodes in metal/air batteries using neutral electrolytes such as seawater or other aqueous saline solutions. FIG. 1 illustrates the construction of a metal/air battery 10, which includes a housing 11 defining a chamber 12, adapted to be substantially filled with a body of a liquid electrolyte 14 such as (for example) an aqueous solution of sodium chloride. A sheet like air cathode 16 having opposed parallel major surfaces respectively designated 17 and 18 is mounted in one wall of the housing 11 so that the cathode major surface 17 is exposed to and in contact with the contained body of electrolyte 14, while the other cathode major surface 18 is exposed to the ambient air outside the chamber. The housing 11 defines a large vertical aperture across which the air cathode extends, with the periphery of the cathode sealed to the periphery of the housing aperture in a liquid-tight manner. A metal (e.g. aluminum) anode 20, shown as mounted in a lid 22 of the housing 11, and having the form of a plate with opposed parallel major surfaces, extends downwardly into the body of electrolyte 14 in the chamber 12. The anode 20 is disposed with one of its major surfaces in parallel, proximate but spaced relation to the major surface 17 of the air cathode 16 such that there is a small electrolyte-filled gap 24 between the anode and cathode. The general arrangement of this air battery is described as useful to form the cells of the plural-cell battery described in U.S. Pat. No. 4,626,482. External electrical contacts respectively designated 26 and 28 are provided for the cathode and anode of the battery, which is thus, be connected in an electrical circuit 29, e.g. including a switch 30 and a light bulb 32, either alone or in series with one or more other like cells. When the metal-air battery is assembled as shown, filled with electrolyte 14, and connected in the circuit 29 (with the switch 30 closed), the battery produces electricity for energizing and lighting the bulb 32, in known manner.

It is an object of the present invention to provide an air cathode bounded with an endless sidewall paired with an inner anode to form a fuel cell, semi-cell, or battery.

It is another object of the present invention to provide an air cathode paired with an anode to provide and facilitate a total reactionary environment for the anodic material as a fuel in electrochemical cell.

It is another object of the present invention to provide an air cathode paired with an inner anode by geometry of the pair as spherical, cylindrical, conical, or truncated conical to form a fuel cell, semi-cell, or battery.

It is another object of the present invention to provide air cathodes bounded with an endless sidewall and each paired with an inner anode to form a multi-cell anode-cathode generator mounted atop a common reservoir of electrolyte.

### SUMMARY OF THE INVENTION

According to the present invention there is provided an electrochemical cell including the combination of an electrolyte container including an endless side wall bounded by an air permeable exterior surface opposite to a cathodic reaction surface surrounding an internal volume for forming an electrolyte reservoir, the air permeable exterior surface being liquid impermeable, an anode extending in the internal volume of the electrolyte container in a confronting and spaced relation from the reaction surface, electrical conductive terminals coupled to the cathodic reaction surface and the anode respectively. Preferably, the cathodic reaction surface is centered about a central axis and may take the form of a cylinder, a cone including a truncated cone, a cup, or a sphere.

According to a further aspect of the present invention there is provided a method for making an electrochemical cell including the steps of forming an electrolyte reaction surface internally of an electrolyte container having an air permeable and liquid impermeable outer barrier to an endless inner electrolyte reaction surface surrounding an internal volume, arranging an anode in electrolyte contained in the internal volume of the container, and providing electrical conductors to transmit an electrical potential between the reaction surface and the anode.

According to a further aspect of the present invention there is provided a method for making electrochemical cells including the steps of forming an endless electrolyte reaction surface in an internal volume of each of a plurality of electrolyte containers, forming an air permeable and liquid impermeable outer barrier to the electrolyte reaction surface of each of the plurality of electrolyte containers, arranging the plurality of electrolyte containers in a case with the internal volume electrolyte reaction surfaces in fluid communication with an internal volume of the case, arranging an anode in electrolyte contained in the internal volume of each of the plurality of electrolyte containers, and providing electrical conductors to transmit an electrical potential between the reaction surfaces and the anodes of the plurality of electrolyte containers.

### BRIEF DESCRIPTION OF THE SEVERAL VIEWS OF THE DRAWINGS

The present invention will be more fully understood when the following description is read in light of the accompanying drawings in which:

FIG. 1 is a schematic elevational view of a prior art air cathode of a metal-air battery;

FIG. 2 is an elevational view, partly in section, to illustrate an electrolytic cell utilizing spherical cathode and anode members according to a first embodiment of the present invention;

FIG. 3 is a dieline for forming a blank used to form the spherical cathode member according to the first embodiment of the present invention;

FIG. 4 is an isomeric illustration of an electrolytic cell utilizing a cylindrical cathode and an anode according to a second embodiment of the present Invention;

FIG. 5 is an elevational view section taken along lines V-V of FIG. 4;

FIG. 6 is a dieline for forming a blank used to form the cylindrical cathode member according to the second embodiment of the present invention;

FIG. 7 is an elevational view in section, similar to FIG. 5, illustrating a modified embodiment of an electrolytic cell with a cylindrically shaped cathode and anode according to a third embodiment of the present Invention;

FIG. 8 is an elevational view in section, similar to FIG. 5, illustrating an electrolytic cell with a conical cathode and anode according to a fourth embodiment of the present Invention;

FIG. 9 is a dieline for forming a blank used to form the conical cathode member according to the fourth embodiment of the present invention;

FIG. 10 is a plane view partly in section of a first embodiment of aluminum air battery according to of the present Invention using electrochemical cells according the second embodiment of FIGS. 3 and 4;

FIG. 11 is side elevational view in section taken along lines XI-XI of FIG. 10;

FIG. 12 is a side elevational view in section similar to FIG. 11 and illustrating a second embodiment of aluminum air battery;

FIG. 13 is a side elevational view in section similar to FIGS. 11 and 12 and illustrating a third embodiment of aluminum air battery;

FIG. 14 is a fragmentary plane view of two electrochemical cells according to the present Invention coupled electrically in series; and

FIG. 15 is a fragmentary plane view of two electrochemical cells according to the present Invention coupled electrically in parallel.

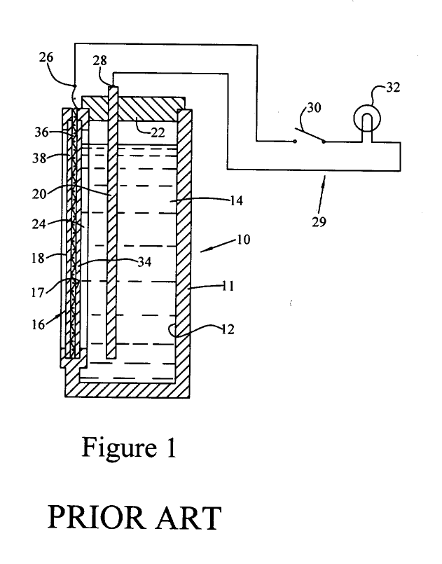

### DETAILED DESCRIPTION OF THE INVENTION

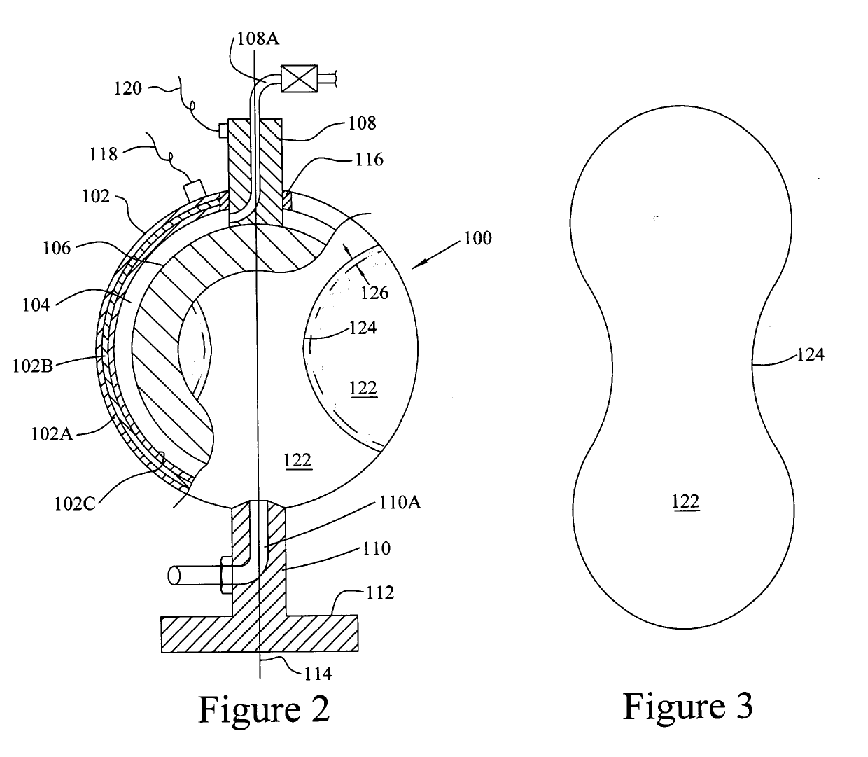

FIG. 2 illustrates a first embodiment of an electrochemical cell 100 according to the present invention, which features a hollow spherical configuration of an air cathode 102 surrounding a spherical electrolyte reservoir 104. A spherical anode 106 is in held in a confronting relation in the internal volume of the air cathode 102 in a generally uniform spaced apart relation by upper and lower polar supports 108 and 110, respectively. The lower polar support 110 includes a support base 112. The polar supports 108 and 110 are arranged to extend along a central vertical axis 114 and made from either electrically nonconductive material e.g. plastic or, if desired and as shown, electrically conductive and electrically isolated from the air cathode by electrically nonconductive sleeves 116. The cathode 102 is constructed of the air permeable composite wall, per se, well known in the art and, as described earlier, takes the form of an endless outer side boundary wall with an air permeable externally facing layer 102A exposed to the atmosphere external to the cell. The facing layer 102A is liquid impermeable to prevent the loss of electrolyte from the reservoir 104. Suitable electrolyte can be selected from the group consisting of solutions, aqueous solutions, ionic conductive liquid gel and semi-solid electrolytic solutions of sodium chloride, calcium chloride, sodium hydroxide, potassium hydroxide and borax. An internal layer 102B is comprised of an electrically conductive layer of wire mesh and screen that support a layer 102C of the active carbon and a dissociation-promoting catalyst containing a finely divided hydrophobic polymeric material near the electrically conductive element. The layer of wire mesh and screen used as a current collecting conductive element is embedded in the sidewall of the air cathode and electrically connected to a conductive lead 118. A cathodic reaction internal wall layer 102C of the air cathode is centered about the central vertical axis 114 and forms a boundary to an interface between the air permeable external face surface 102A for passage of a supply of oxygen containing gas to the liquid permeable internal wall layer of the internal face surface 102C of the air cathode. The cathodic reaction surface 102C is an electrolyte reaction surface extending internally of the electrolyte container comprised of the air cathode 102. Suitable anodic materials to form the anode 106 include but are not limited to anodic materials selected from the group consisting of aluminum, alloys of aluminum, alloys of magnesium, zinc, lithium, iron, sodium, and calcium. An electrical conductive lead 120 is connected to the anode 106, which together with electrical conductive lead 118 apply the electrical potential generated by the electrochemical cell to an external resistive electrical load. The upper and lower polar supports 108 and 110 contain internal passages 108A and 110A, respectively, in communication with the electrolyte reservoir 104 for managing the quantity of an electrolyte in the electrolyte reservoir 104 and the supply and discharge of liquid electrolyte through operation of associated control valves 108B and 110B. The control valve 108B for the upper polar support 108 is placed in an open position to allow free passage of gases, notably hydrogen gas, generated during operation of the electrochemical cell to the atmosphere or an external collection vessel, not shown. FIG. 3 illustrates a die cut air cathode blank 124 of two identical die cut air cathode blanks that used to form the spherical air cathode 102. The blank 124 takes the familiar form of a blank used to form the covering on a baseball and softball, however, the use of two blanks differs in the fact that the blanks are sized to provide an overlap 126 between the marginal edges of the blanks as illustrated in FIG. 2. The overlap 126 provides a liquid impervious adhesion site of long continued integrity.

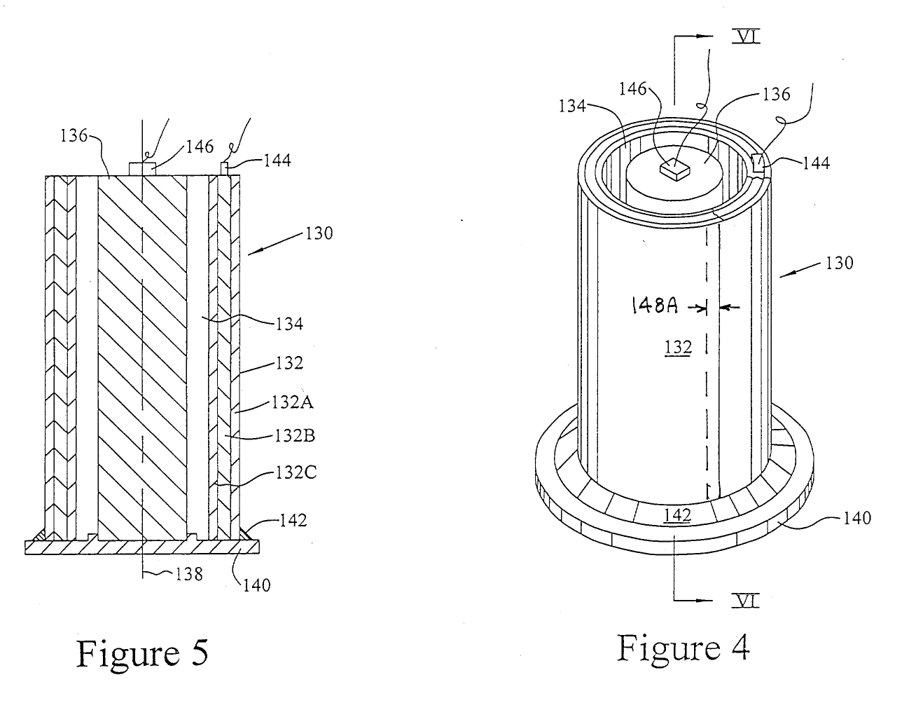

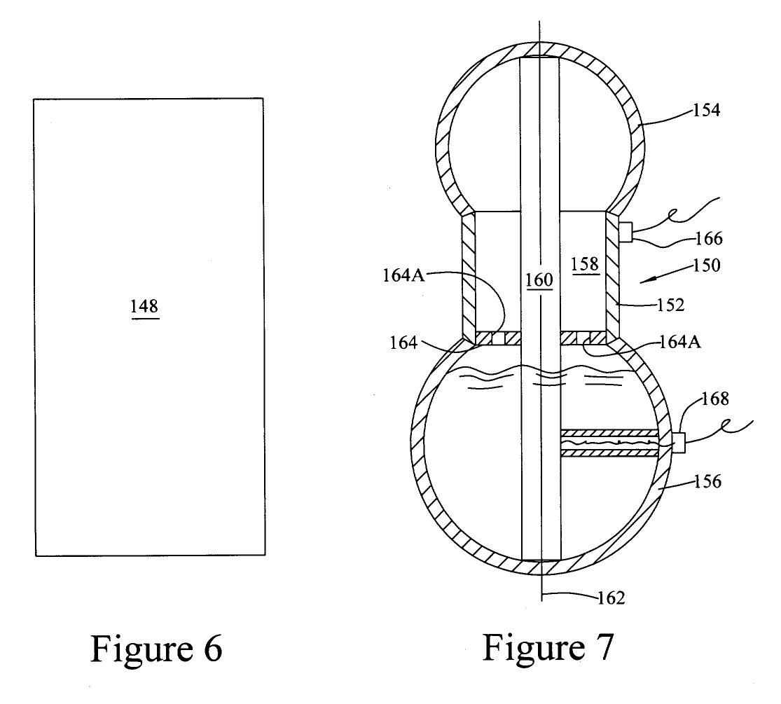

FIGS. 4 and 5 illustrate a second embodiment of an electrochemical cell 130 according to the present invention that features a hollow cylindrical configuration of an air cathode 132 forming a cup shaped electrolyte reservoir 134 and in a confronting relation with a cylindrically shaped anode 136 in the internal volume of the air cathode 132. The electrolyte is selected from the same group of ionic solutions as listed in the description of the first embodiment. The cylindrically shaped anode 136 extends along a central vertical axis 138 and is held in a generally uniform spaced apart relation from the air cathode 132 by lower base plate 140 made of plastic or other suitable non-electrically conductive material. The cathode 132 has the same wall construction as air cathode 102 of the embodiment shown in FIG. 2. An adhesive layer 142 seals the air cathode 132 to the base plate 140. The component parts of the air cathode 132 are the same as described in the first embodiment but constructed according to the second embodiment of the present invention to form a cylindrically shaped, endless outer side boundary wall with an air permeable external face layer 132A exposed to the atmosphere externally of the cell. The external face layer 132A is liquid impervious to prevent the loss of the liquid electrolyte in reservoir 134. An internal layer of metal screen and mesh 132B used as an electrically conductive element is joined electrically to a conductive lead 144. The air cathode further includes an internal boundary layer 132C of active carbon and a dissociation-promoting catalyst containing a finely divided hydrophobic polymeric material near the electrical conductive element comprised of the layer 132B. A cathodic reaction internal boundary layer 132C of the air cathode is centered about the central axis 138 and forms a boundary to the interface between the air permeable external face surface 132A for passage of oxygen containing gas to the liquid permeable internal boundary layer 132C of the air cathode. Materials comprising the anode 136 are selected from the same list of the materials described for anode 106. An electrical conductive lead 146 is connected to the anode, which together with electrical conductive lead 144 apply the electrical potential generated by the electrochemical cell to an external resistive electrical load. The top of the electrolytic cell 130 may be enclosed by upper end cap, not shown, containing gaseous permeable openings to allow free passage of gases generated during operation of the electrochemical cell to the atmosphere. Such an upper end cap may be removable or provided with openings for access to manage the supply of an electrolyte in the electrolyte reservoir 134. FIG. 6 illustrates a die cut air cathode blank 148 used to form the cylindrical air cathode 132. The blank 148 takes the familiar form of a rectangle having a length sufficient for wrapping into a cylindrical form with and overlap 148A between opposite marginal edges as illustrated in FIG. 4. The overlap 148A provides a liquid impervious adhesion site of long continued integrity.

FIG. 7 illustrates a third embodiment of an electrochemical cell 150 according to the present invention that is a modification to the second embodiment shown in FIGS. 4 and 5 and features a hollow cylindrically shaped configuration of an air cathode 152 with upper and lower hemispherical housings 154 and 156, respectively, to enclose opposite ends of the volume of a cylindrically shaped electrolyte reservoir 158. A cylindrically shaped anode 160 extends along a central vertical axis 162 and centered along the volume of the reservoir by passage through an aperture in an end cap 164 into a seated relation against the hemispherical housings 154 and 156. By this construction of parts, the anode is held in a confronting relation in the internal volume of the air cathode. The end cap 164 also includes apertures 164A to allow passage of electrolyte to and from reservoir 158 from the storage chamber comprised of the lower hemispherical housing 156. The upper hemispherical housing 154 has an internal volume which is much less than the internal volume of the lower hemispherical housing 156 so that by inverting the electrochemical cell 180degrees, the electrolyte in lower hemispherical housing 154 will fill the volume of both the upper hemispherical housing 156 and the cylindrically shaped electrolyte reservoir 158, thus energizing the electrochemical cell for the production of electrical current appearing across the electrical terminals 166 and 168. Reversing the orientation of the electrochemical cell stops the production of electrical current by returning the entire electrolyte into the lower hemispherical housing 156.

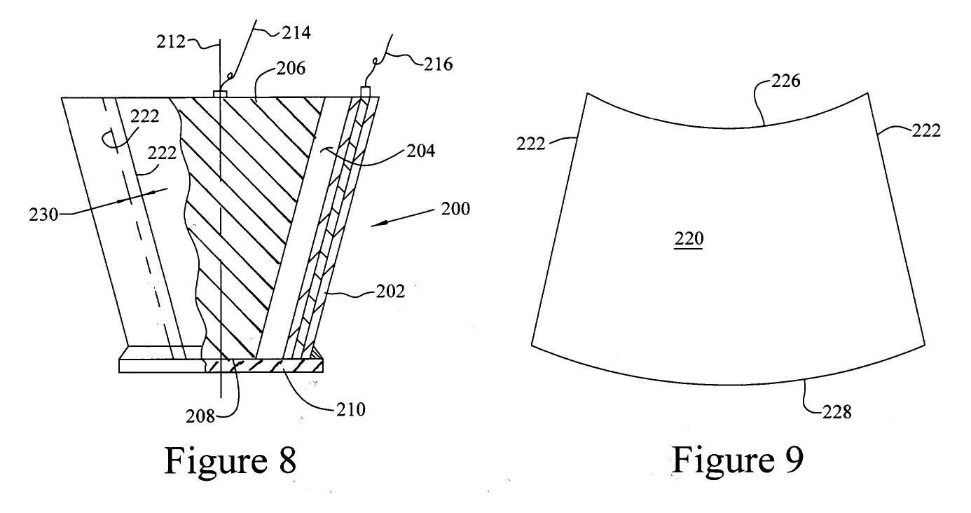

FIGS. 8 and 9 illustrate a third embodiment of an electrochemical cell 200 according to the present invention that features a hollow conically shaped configuration of an air cathode 202. The conically shaped configuration of the cathode is truncated, as shown, to enclose a volume forming a truncated conically shaped electrolyte reservoir 204. A truncated conically shaped anode 206 has a planer end face 208 in a supporting relation on an under lying base plate 210 so that the other conical surface of the anode is arranged in a confronting relation in the internal volume of the air cathode and in a generally uniform spaced apart relation. A layer of adhesive is used to seal and secure the base plate 210 to the air cathode 202. The geometrical configuration of the cathode 202 and the anode 206 is such each extends along a central vertical axis 212. Energizing the electrochemical cell by the introduction of the electrolyte into the electrolyte reservoir 204 produces electrical current appearing across the electrical terminals 214 and 216. The air cathode 202 and anode 206 embody the same materials of construction as illustrated in FIGS. 2-7 and the accompanying description hereinbefore. FIG. 9 illustrates a die cut air cathode blank 220 used to form the truncated conical air cathode 202. The blank 220 takes the form of opposed side edges 222 tapering in the same direction toward an annular top edge 226 whose radius of curvature is less than the radius of curvature of a bottom edge 228. The size of the blank is designed to provide an overlap 230 between the marginal side edges 222 of the blank as illustrated in FIG. 8. The overlap 230 provides a liquid impervious adhesion site of long continued integrity.

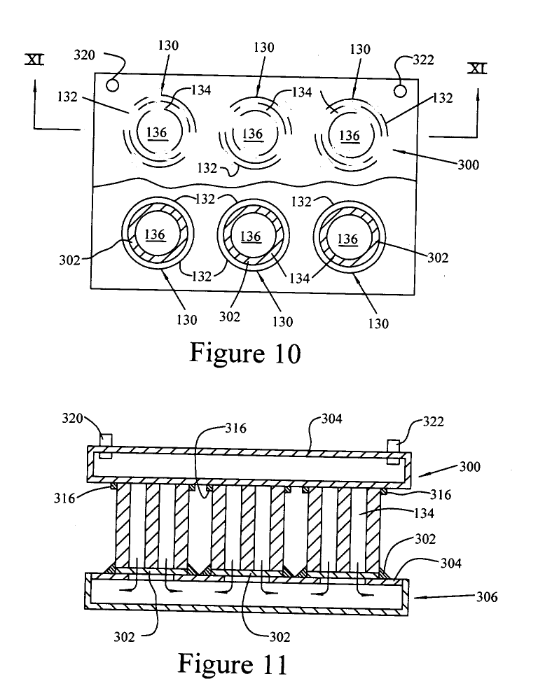

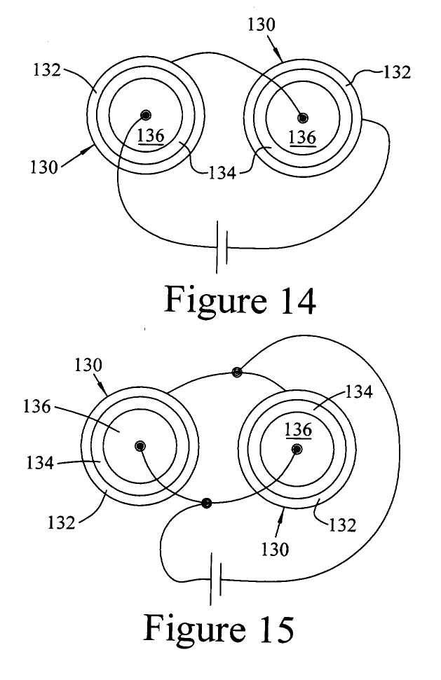

FIGS. 10 and 11 illustrate a first embodiment of a battery using an array 300 of electrochemical cells 130 as collection in a battery case with the cylindrical cathodes 132 and anodes 136 embody the same materials of construction as illustrated in FIGS. 2-9 in accordance with the accompanying description. The cylindrically shaped cathodes are mounted as a spatial array on discs 302 of electrolyte pervious mesh made of plastic or other electrically non-conductive material. The discs 302 are mounted upon a top wall 304 of a bottom case 306 having a hollow interior for retaining a volume of electrolyte and communicating via apertures 308 in the top wall 304 with the electrolyte reservoirs 134 of each electrolytic cell. The discs 302 are positioned to allow solid participate generated in each reservoir to pass with the influence of gravity from each reservoir of the electrolytic cells into the hollow interior case 306. The anodes 136 of each of the cells are supported by the fluid pervious mesh of the discs 302 to maintain the anodes above the interior of the bottom case 306 for avoiding the establishment of a electrical shunt. Electrical conductors for the array of electrochemical cells are housed and connected to the cathodes and electrodes of the electrolytic cells within a top case 310 according to one of the electrical configurations shown in FIGS. 14 and 15 to provide an electrical potential appearing across battery pole pieces 312 and 314. The top case includes support rings 316 to receive and stabilize the top case on the array of electrolytic cells. Apertures, not shown, are formed in the top case to allow venting or collection of gasses liberated by the electrolyte in the reservoirs of the cells. The bottom case 306 is made of material different from the materials of the air cathode and the material of the anode to prevent any electrochemical reaction with the material of the case. The use of the common case 306 facilitates manufacture of the complete electrochemical battery, as well as replacement of depleted anodes and removal of the reacted materials collected in the case.

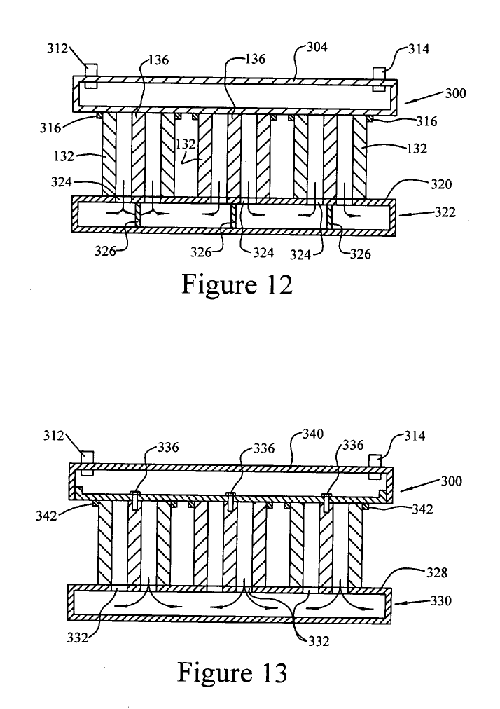

FIG. 12 illustrates a second embodiment of a battery using the same array 300 of electrochemical cells 130 as collection in a battery case with the cylindrical cathodes 132 and anodes 136 embody the same materials of construction as illustrated in FIGS. 2-9 in accordance with the accompanying description. The cylindrically shaped cathodes are mounted and secured by adhesive as a spatial array upon a top wall 320 of a bottom case 322 having a hollow interior for retaining a volume of electrolyte. Apertures 324 in the top wall 320 the electrolyte reservoirs 134 of each electrolytic cell and the hollow interior of the case and allow solid participate generated in each reservoir to pass with the influence of gravity from each reservoir of the electrolytic cells into the hollow interior case. The anodes 136 of each of the cells are supported and retained in the reservoir of the cells by support post 326 to maintain the anodes above the top wall 320 of the bottom case 322 for avoiding the establishment of a electrical shunt. Electrical conductors for the array of electrochemical cells are housed and connected to the cathodes and anodes of the electrolytic cells within the top case 310 according to one of the electrical configurations shown in FIGS. 14 and 15 to provide an electrical potential appearing across battery pole pieces 312 and 314. The top case includes the support rings 316 on the lower face surface of the top case to receive and stabilize the top case on the array of electrolytic cells. Apertures, not shown, are formed in the top case to allow venting or collection of gasses liberated by the electrolyte in the reservoirs of the cells. The bottom case 322 is made of material different from the materials of the air cathode and the material of the anode to prevent any electrochemical reaction with the material of the case FIG. 13 illustrates a third embodiment of a battery using the same array 300 of electrochemical cells 130 as collection in a battery case with the cylindrical cathodes 132 and anodes 136 embody the same materials of construction as illustrated in FIGS. 2-9 in accordance with the accompanying description. The cylindrically shaped cathodes are mounted and secured by adhesive as a spatial array upon a top wall 328 of a bottom case 330 having a hollow interior for retaining a volume of electrolyte. Apertures 332 in the top wall 328 of the bottom case established a pathway for electrolyte in the electrolyte reservoirs 134 of each electrolytic cell and the hollow interior of the case and allow solid participate generated in each reservoir to pass with the influence of gravity from each reservoir of the electrolytic cells into the hollow interior case. The anodes 136 of each of the cells are secured by threaded fasteners 336, such as bolts, for support by a lower wall 338 forming part of a two piece top case 340 to maintain the anodes above the interior of the bottom case 330 for avoiding the establishment of a electrical shunt. Electrical conductors for the array of electrochemical cells are housed and connected to the cathodes and anodes of the electrolytic cells within a top case 340 according to one of the electrical configurations shown in FIGS. 14 and 15 to provide an electrical potential appearing across battery pole pieces 312 and 314. The lower wall 238 top case includes support rings 342 on the lower face surface to receive and stabilize the array of electrolytic cells. Apertures, not shown, are formed in the top case to allow venting or collection of gasses liberated by the electrolyte in the reservoirs of the cells.

The electrical configuration shown in FIG. 14 is a partial a fragmentary plane view of only two electrochemical cells coupled electrically in series and forms part of the array shown in FIGS. 10-13. The series coupling of the cells 130 is accomplished by interconnecting the air cathode of one of the cells to the anode of another of the cells in the array. The battery pole piece 312 is electrical connected to one-half of the series connected cells and the battery poll piece 314 is electrically connected to the remaining half of the series connected cells.

The electrical configuration shown in FIG. 15 is a partial a fragmentary plane view of only two electrochemical cells coupled electrically in parallel and forms part of the array also shown typically in FIGS. 10 and 11. The parallel coupling of the cells 130 is accomplished by electrically interconnecting the air cathodes of all of the cells together and connected to battery poll piece 312. The parallel coupling is completed by electrically interconnecting all of the anodes of all of the cells in the array and connected electrically to battery poll piece 314.

The use of the component configurations in an electrochemical relationship offers the improvement to produce a power output that is as close to 100% (or in a ration of 1 to 1) of the power available by combining the geometrical configurations of the cathode and anode components. The operational efficiency of an electrochemical cell is enhanced by the geometry of components that maximizes the electrochemical conversion processes in an air cathode paired with an anode to facilitate a total reactionary environment for the anodic material as a fuel in electrochemical cell. The cathode surrounds the anode, providing 360 degrees of a reaction site between the ration of anodic to catholic surface area.

While the present invention has been described in connection with the preferred embodiments of the various figures, it is to be understood that other similar embodiments may be used or modifications and additions may be made to the described embodiments for performing the same function of the present invention without deviating there from. Therefore, the present invention should not be limited to any single embodiment, but rather construed in breadth and scope in accordance with the recitation of the appended claims.

1. An electrochemical cell including the combination of:
an electrolyte container including an endless side wall bounded by an air permeable exterior surface opposite to a cathodic reaction surface surrounding an internal volume for forming an electrolyte reservoir,
said air permeable exterior surface being liquid impermeable,
an anode extending in said internal volume of said electrolyte container in a confronting and spaced relation from said reaction surface,
electrical conductive terminals coupled to said cathodic reaction surface and said anode respectively.

2. The electrochemical cell according to claim 1 wherein said cathodic reaction surface is centered about a central axis.

3. The electrochemical cell according to claim 1 wherein said cathodic reaction surface of said electrolyte container is cylindrically shaped.

4. The electrochemical cell according to claim 1 wherein said cathodic reaction surface of said electrolyte container is conically shaped.

5. The electrochemical cell according to claim 1 wherein said cathodic reaction surface of said electrolyte container has the shape of a truncated cone.

6. The electrochemical cell according to claim 1 wherein said cathodic reaction surface of said electrolyte container is cup shaped.

7. The electrochemical cell according to claim 1 wherein said cathodic reaction surface of said electrolyte container is spherical.

8. The electrochemical cell according to claim 1 further including a passageway communicating with said air permeable exterior surface for supplying oxygen containing gas.

9. The electrochemical cell according to claim 1 further including a conduit for managing the supply of an electrolyte in said electrolyte reservoir.

10. A method for making an electrochemical cell including the steps of:
forming an electrolyte reaction surface internally of an electrolyte container having an air permeable and liquid impermeable outer barrier to an endless inner electrolyte reaction surface surrounding an internal volume,
arranging an anode in electrolyte contained in the internal volume of the container, and
providing electrical conductors to transmit an electrical potential between the reaction
surface and the anode.

11. The method for making an electrochemical cell according to claim 10 including the further step of providing a control for adjusting the quantity of electrolyte in said electrolyte container.

12. The method for making an electrochemical cell according to claim 10 including the further step of selecting said electrolyte container with a cylindrical configuration.

13. The method for making an electrochemical cell according to claim 10 including the further step of selecting said electrolyte container with a truncated conical configuration.

14. The method for making an electrochemical cell according to claim 10 including the further step of selecting said electrolyte container with a conical configuration.

15. The method for making an electrochemical cell according to claim 10 including the further step of selecting said electrolyte container with a spherical configuration.

16. A method for making electrochemical cells including the steps of:
forming an endless electrolyte reaction surface in an internal volume of each of a plurality of electrolyte containers,
forming an air permeable and liquid impermeable outer barrier to the electrolyte reaction surface of each of the plurality of electrolyte containers,
arranging the plurality of electrolyte containers in a case with the internal volume electrolyte reaction surfaces in fluid communication with an internal volume of the case,
arranging an anode in electrolyte contained in the internal volume of each of the plurality of electrolyte containers, and
providing electrical conductors to transmit an electrical potential between the reaction surfaces and the anodes of the plurality of electrolyte containers.

17. The method for making an electrochemical cell according to claim 16 including the further step of providing a control for adjusting the quantity of electrolyte in each of said electrolyte containers in a superimposed relation.

18. The method for making an electrochemical cell according to claim 16 wherein each of said a plurality of electrolyte containers includes said cathodic reaction surface centered about a central axis and wherein a said step of arranging two of said a plurality of electrolyte containers in a superimposed relation includes arranging the central axis of the superimposed electrolyte containers in an aligned and coextensive relation.
